(19) United States
(12) Patent Application Publication
(10) Pub. No.: US 2013/0222908 A1
(43) Pub. Date: Aug. 29, 2013

(54) OPTICALLY ISOLATED TO-CAN

(71) Applicants: XIAN-LI YEH, WALNUT, CA (US); TIRONG CHEN, AZUSA, CA (US)

(72) Inventors: XIAN-LI YEH, WALNUT, CA (US); TIRONG CHEN, AZUSA, CA (US)

(21) Appl. No.: 13/464,027

(22) Filed: May 4, 2012

Related U.S. Application Data
(60) Provisional application No. 61/603,027, filed on Feb. 24, 2012.

(51) Int. Cl. G02F 1/09; B23P 17/04; G02B 27/28

(52) U.S. Cl. 359/484.03; 359/483.01; 29/428

(57) ABSTRACT

An optically isolated TO-can including a header with electrical connections, a laser diode mounted on the header, and a lens cap positioned over the laser diode so as to enclose and hermetically seal the laser diode. The optically isolated TO-can includes an optical isolator positioned in the TO-can adjacent the laser diode and in the light path of light generated by the laser diode.

### CROSS-REFERENCE TO RELATED APPLICATION

This application claims the benefit of U.S. Provisional Patent Application No. 61/603,027, filed 24 Feb. 2012.

### FIELD OF THE INVENTION

This invention relates to optical isolation of a semiconductor laser from optic fibers.

### BACKGROUND OF THE INVENTION

Semiconductor lasers, mostly Distributed Feedback (DFB) lasers and Fabry-Perot (FP) lasers, are commonly used for transmitting signals over optic fibers in modern telecommunications and data communications. FP lasers are typically used for transmitting short distances (e.g., under 2 km), whereas DFB lasers are typically used for transmitting distances between of 2 km and 80 km. These lasers are typically being packaged in TO-Cans which in turn are assembled into a Transmitting Optical Sub-Assembly (TOSA) or a Bidirectional Optical Subassembly (BiDi) before being installed into Optical transceiver modules. Unlike FP lasers, DFB lasers generate a single wavelength optical output through a built-in grating based on Bragg reflection. The DFB lasers are very sensitive to external optical feedback through the front facet into the laser cavity. The deleterious feedback can be caused by small reflections from optical elements such as coupling lenses and/or the optic fiber end face coupled to the output face of the DFB laser and/or by reflections from the far end of the fiber network (such as optic fiber connectors or detectors).

The optical reflection or feedback will cause significant performance degradation of DFB lasers, such as reduction of Side Mode Suppression Ratio or increase of Relative Intensity Noise and broadening of laser line width. In some cases, another optical mode can become so strong the laser no longer has the single mode output. These performance degradations in turn cause errors in signal transmission so that the transceiver module can fail to meet the system specifications.

In order to reduce the laser performance degradation caused by optical feedback, an optical isolator is typically installed between the TO-can and the end of the optic fiber. The optical isolator typically used for this application is composed of an input polarizer which has the same polarization as the DFB laser, a Faraday rotator with 45 degree rotation and an exit polarizer which has a 45 degree polarization with respect to the first or input polarizer. The optical isolator lets the output of the laser pass through but will block light feedback from the fiber end (the principle of the optical isolator can be found in prior art literature).

However, as the demand for DFB lasers increases, the market pressure for lower cost devices incorporating DFBs also increases. The existing packaging methods for optical isolation in DFB, TOSA, or BiDi devices are becoming too costly for the current market needs.

It would be highly advantageous, therefore, to remedy the foregoing and other deficiencies inherent in the prior art.

Accordingly, it is an object of the present invention to provide new and improved optically isolated TO-Cans.

It is another object of the present invention to provide new and improved optically isolated TO-cans that are easier and cheaper to manufacture.

It is another object of the present invention to provide new and improved methods of optically isolating lasers and optical fibers to achieve precise polarization alignment and to achieve precise positioning placement.

### SUMMARY OF THE INVENTION

Briefly, to achieve the desired objects of the instant invention in accordance with a preferred embodiment thereof, an optically isolated TO-can is provided including a header with electrical connections, a laser diode mounted on the header, and a lens cap positioned over the laser diode so as to enclose and hermetically seal the laser diode. The optically isolated TO-can includes an optical isolator positioned in the TO-can adjacent the laser diode and in the light path of light generated by the laser diode. In the preferred embodiment the spacing of the lens from the laser diode is increased by a distance equal to the actual thickness of the optical isolator minus the effective thickness of the optical isolator and the optical isolator is positioned inside the TO-can close enough to the laser diode to substantially reduce the required aperture size.

The desired objects of the instant invention are further realized in accordance with a preferred method of fabricating an optically isolated TO-can including a header with electrical connections, a laser diode mounted on the header, and a lens cap positioned over the laser diode so as to enclose and hermetically seal the laser diode, and the lens cap including a lens in an end thereof spaced from the laser diode and positioned to direct generated light in a light path into an optical fiber. The method includes the steps of positioning an optical isolator in the TO-can adjacent the laser diode and in the light path of light generated by the laser diode and adjusting the spacing of the laser diode from the lens to compensate for the optical isolator. Preferably, the method further includes the step of positioning the optical isolator inside the TO-can close enough to the laser diode to substantially reduce the required aperture size.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified side view of a typical prior art optical laser coupling system;

FIG. 2 is a perspective view of an optically isolated TO-can laser system in accordance with the present invention;

FIG. 3 is a front view of the optically isolated TO-can laser system of FIG. 2, with TO-can shown in phantom;

FIG. 4 is a side view of the optically isolated TO-can laser system of FIG. 2, with TO-can shown in phantom;

FIG. 5 is a schematic view of the diffusion of generated light and the focusing onto an optic fiber; and

FIG. 6 is a front view of another example of an optically isolated TO-can laser system in accordance with the present invention; and

FIG. 7 is a perspective view of another example of an optically isolated TO-can laser system in accordance with the present invention.

### DETAILED DESCRIPTION OF A PREFERRED EMBODIMENT

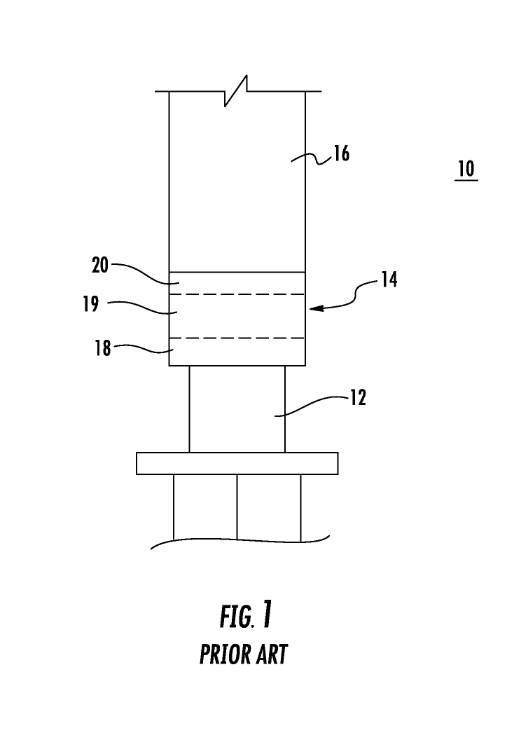

Turning now to FIG. 1, a simplified side view of a typical prior art optical laser coupling system 10 is illustrated. System 10 includes a laser mounted in a TO-can 12 in a manner well known in the prior art. As explained above, the laser is typically a DFB laser, which is affected the most by feedback light. Laser light generated by the laser within TO-Can 12 is outputted through the upper end of TO-Can 12, which includes a focusing lens, passes through an optical isolator 14, and into an optic fiber 16. In a typical TOSA, optic fiber 16 is a fiber stub which is a mating polished fiber section that optically couples the laser beam to an output receptacle. The TOSA can then be conveniently coupled to an optical fiber transmission system by plugging an optical fiber into the output receptacle.

Optical isolator 14 is a typical isolator including an input polarizer 18 having the same polarization as the DFB laser in TO-can 12. Isolator 14 further includes a Faraday rotator 19 that rotates the polarization of the incoming light 45 degrees and an exit polarizer 20 which has a 45 degree polarization in respect to the polarization of polarizer 18. As is understood in the art, light from the laser diverges up to a maximum beam diameter at the focusing lens in the lens cap of TO-can 12. The focusing lens then focuses or converges the light onto the surface of optic fiber 16. Thus, the aperture of isolator 14 must be large enough to accommodate the beam diameter. One major problem with this system is the difficulty of aligning the polarizer in isolator 14 with the laser in TO-can 12.

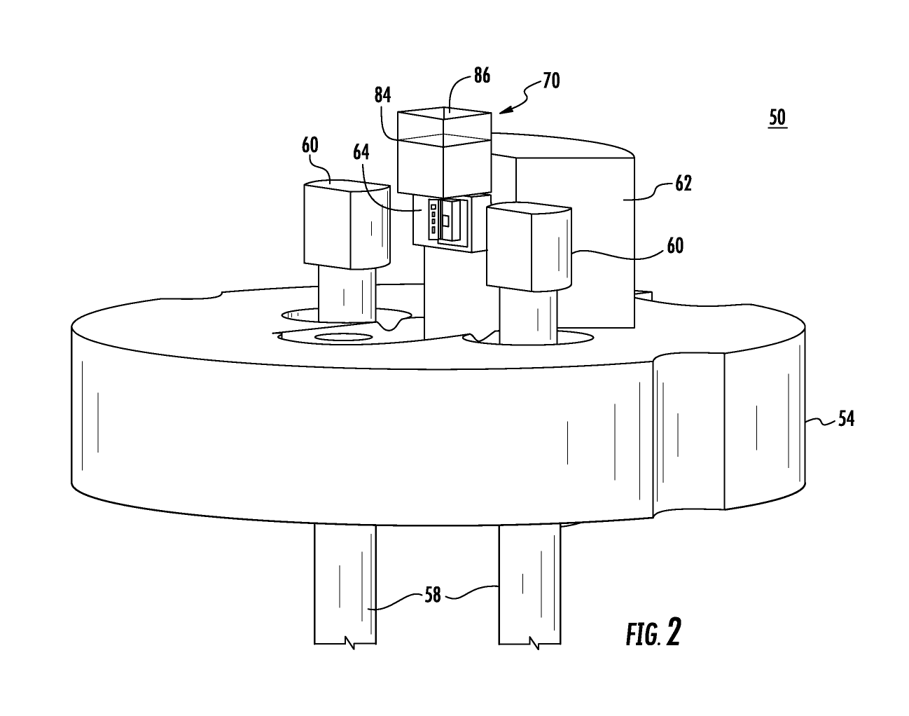

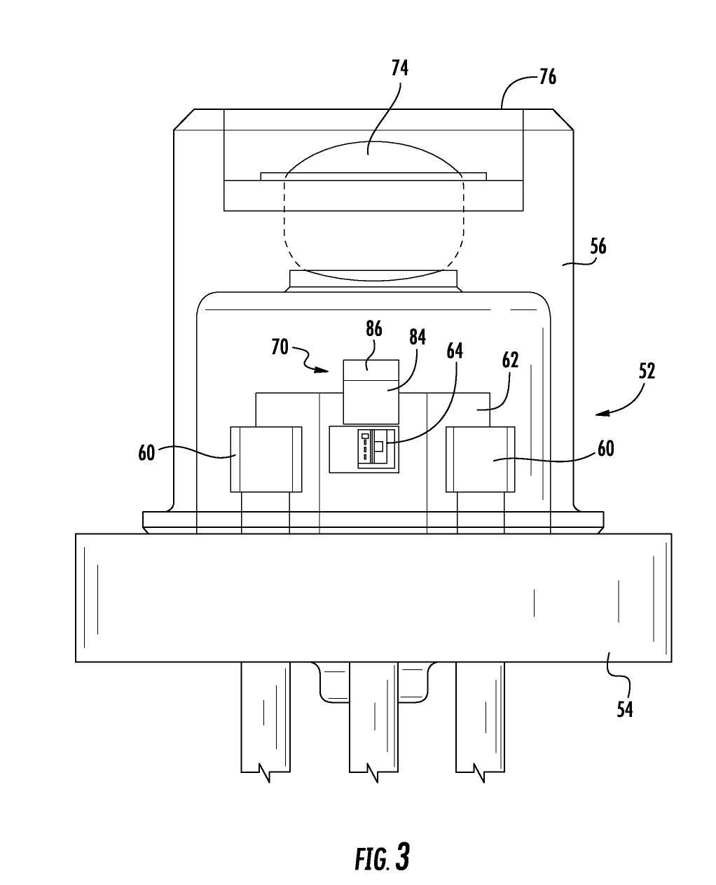

Referring now to FIGS. 2-4, an optically isolated TO-Can laser system 50, in accordance with the present invention, is illustrated. System 50 includes a TO-Can 52 with a base or header 54 and a lens cap 56 attached thereto in a well known manner. TO-Can base 54 has plug-in leads 58 extending downwardly therethrough. At least two of leads 58 have electrical contacts 60 formed at the upper ends (inside TO-can 52) to provide internal connections to the laser diode and any photodiodes or other devices included in TO-can 52. A mounting block or component mounting structure 62 is affixed to the upper surface of base 54 and a laser diode 64 is affixed to the inner face so that the emission face of laser diode 64 is approximately horizontally centered in TO-can 52. An optical isolator 70 is affixed to the upper surface of laser diode 64.

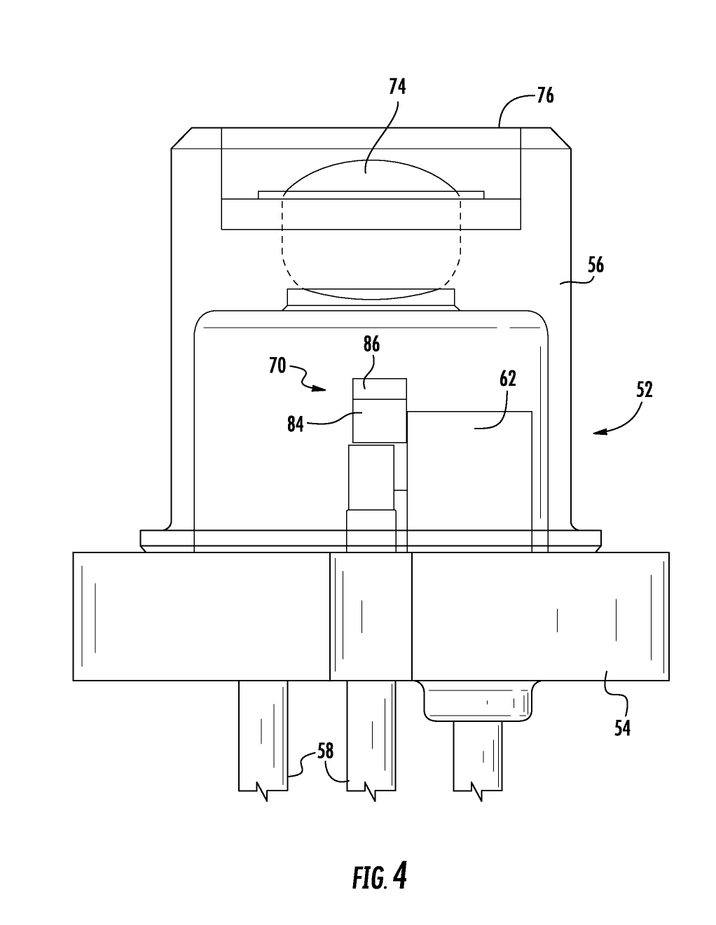

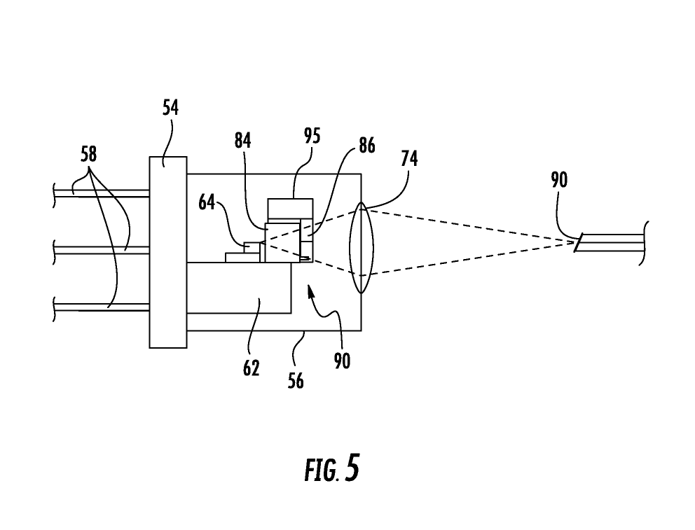

As can be seen in FIG. 4, lens cap 56 is engaged with base 54 over laser diode 64 and optical isolator 70 so as to enclose and hermetically seal the components. Lens cap 56 typically includes an aspheric lens or ball lens 74 mounted in the upper end thereof. Lens 74 focuses light generated in laser diode 64 onto the polished face of an optic fiber engaged in or otherwise optically mated and aligned with an opening or depression 76 formed in the outer, upper surface of lens cap 56. The diffusion of generated light and the focusing onto an optic fiber is illustrated schematically in FIG. 5.

Referring specifically to FIG. 5, laser 64 is illustrated in its mounted position on mounting block 62. Isolator 70, including Faraday rotator 84 with a magnet 95 (rather than a latching garnet), and 45 degree polarizer 86, is fixed to mounting block 62 in the light path of laser 64. Lens cap 56 is affixed to base or header 54 in hermetically sealed engagement. As illustrated schematically in this figure, light from laser 64 diffuses outwardly to lens 74. Lens 74 is positioned to focus or converge the light onto the face or polished facet 90 of an optic fiber 92. As understood in the art and illustrated here in simplified form, the facet 90 of optic fiber 92 is generally oriented at 8 degrees to the light output of laser 64 to further reduce light reflected back into laser 64.

Referring specifically to optical isolator 70, a full isolator including a first or input 45 degree polarizer, a Faraday rotator, and a second or output 45 degree polarizer, can be used in some applications. Because isolator 70 is placed very near the facet or output of laser diode 64, the isolator aperture is much smaller than prior art isolators so that the cost of isolator 70 is much lower than prior art isolators. Another advantage of placing isolator 70 inside TO-can 52 inside the hermetically sealed environment is that isolator 70 is immune from water condensation or other contamination in which the system may be operated and, thus, the reliability of the system is improved.

To further reduce the cost, isolator 70 can include a half isolator rather than a full isolator. Half isolator 70 includes only a Faraday rotator designated 84 in FIGS. 2-4, and an exit polarizer, designated 86. In this example, the input polarizer is omitted to further reduce the cost. It should be understood that a half isolator cannot prevent all optical feedback from reaching the facet of laser 64. Light with polarization perpendicular to exit polarizer 86 is blocked by the polarizer whereas light with polarization parallel to exit polarizer 86 will pass through Faraday rotator 84 with an additional 45 degrees of rotation so that the impact on laser 64 will have polarization perpendicular to the polarization of the output beam of laser 64. Thus, interference to laser 64 is not as significant relative to the case when a reflected beam has the same polarization as the laser beam output polarization.

In one working example of the invention, laser 64 is a DFB laser with a 1490 nm wavelength and isolator 70 is a half isolator including Faraday rotator 84, embodied by a latching garnet (i.e. a Faraday rotator without an external magnet) with a thickness of 440 um, and exit polarizer 86 with a thickness of 200 um. By placing isolator 70 between the output facet of laser 64 and lens cap 56, the effective thickness of the half isolator is

T_{garnet}/R_{garnet}+Tₚₒₗₐᵣ/Rₚₒₗₐᵣ=440 um/2.317+200 um/1.51=322 um.

Where: T_{garnet}=the thickness of the garnet;
R_{garnet}=the index of refraction of the garnet;
Tₚₒₗₐᵣ=the thickness of the polarizer; and
Rₚₒₗₐᵣ=the index of refraction of the polarizer.

In order to maintain the same magnification for lens 74, the effective laser-to-lens distance must be kept the same when the half isolator is inserted in the optical path. Therefore, the distance to be compensated is equal to the actual thickness of half isolator 70 minus the effective thickness of half isolator 70, which is 640 um−322 um=310 um. Thus, laser diode 64 must be spaced farther from lens cap 56 by 310 um with half isolator 70 installed as compared to the spacing in the system of FIG. 1, for example. It will be understood that the thickness of the rotator will be different for different wavelengths (e.g. the thickness of the rotator described above will be thinner for a 1310 nm wavelength) which results in a different distance compensation.

A general compensation equation that can be applied to any rotator is:

Tᵣₒₜₐₜₒᵣ/Rᵣₒₜₐₜₒᵣ+Tₚₒₗₐᵣ/Rₚₒₗₐᵣ.

Where: Tᵣₒₜₐₜₒᵣ=the thickness of the rotator;
Rᵣₒₜₐₜₒᵣ=the index of refraction of the rotator;
Tₚₒₗₐᵣ=the thickness of the polarizer; and
Rₚₒₗₐᵣ=the index of refraction of the polarizer.

When half isolator 70 is used in TO-can 52 of system 50 with a DFB laser, it is important to have the polarization of exit polarizer 86 aligned exactly 45 degrees from the laser polarization. As stated above, when feedback or reflected light impinges on half isolator 70 it will pass through exit polarizer 86 but will be rotated 45 degrees by rotator 84 so that its effect on the DFB laser will be greatly reduced.

Another advantage of placing the half isolator inside TO-Can 52 is that the bonding plane (front surface of mounting block 62) is well defined and is parallel to the laser output polarization so that the requirement of exactly 45 degree difference can be relatively easily met. Rather than assembling isolator 70 using the traditional manual assembling process, the isolator can be placed on the TO mounting block using an automatic epoxy die bonder which is both accurate and fast.

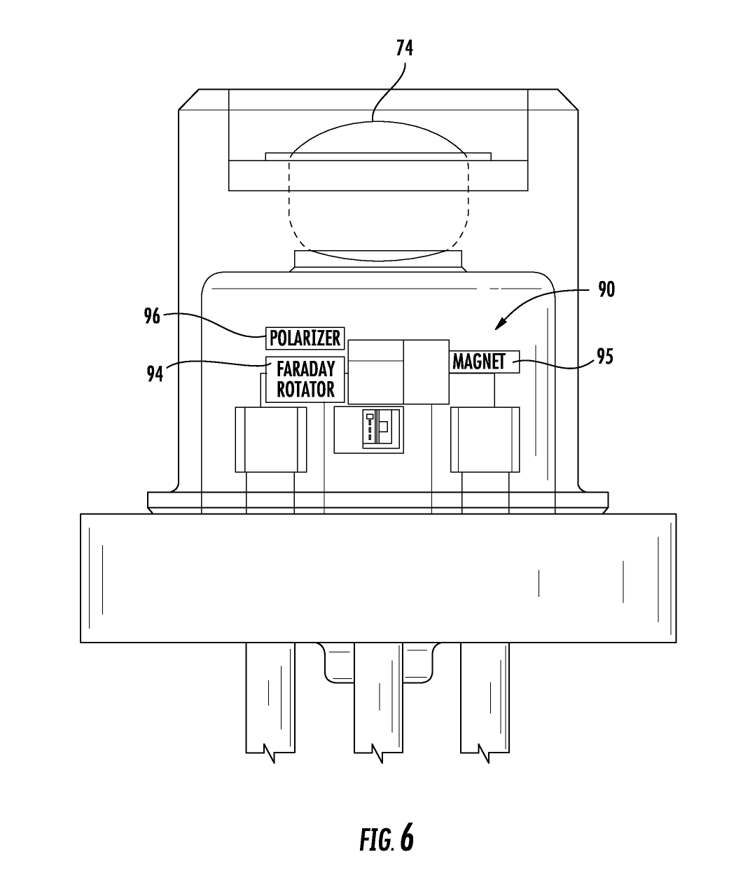

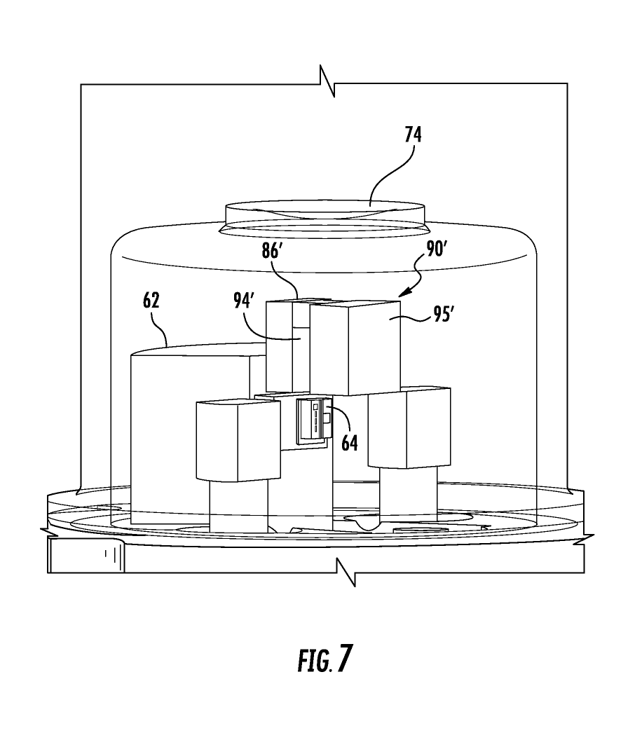

Referring additionally to FIG. 6, another example of an isolator, designated 90, is illustrated. In this example isolator 90 includes a Faraday rotator 94 with an external magnet 95 positioned to one side of Faraday rotator 94 (rather than a latching garnet) and a 45 degree polarizer 96. Referring additionally to FIG. 7, another example of an isolator, designated 90′, is illustrated. In this example isolator 90′ includes a Faraday rotator 94′ with an external magnet 95′ positioned on top of Faraday rotator 94′. It will be understood that magnets for Faraday rotators can be placed in a variety of positions and, also, other rotators and polarizers may be used and the important concept of the present invention is the integration of the isolator into the TO-can adjacent to the laser facet. In fact, it is desirable to place the isolator as close to the laser front facet as possible so that the entire diverging laser beam (see FIG. 5) will enter the isolator through the front or bottom isolator surface and pass through the isolator with no part of the beam hitting the side wall.

Thus, a new and improved optical isolation system is illustrated and described. The improved optical isolation system is relatively inexpensive and easy to manufacture. By placing the optical isolator inside the TO-can and near the laser facet the required aperture size is substantially reduced, substantially reducing the size of the isolator and the cost. Also, the isolator can be quickly and conveniently placed inside the TO-can by using an automatic epoxy die bonder. Therefore, new and improved methods of optically isolating lasers and optical fibers to achieve precise polarization alignment and to achieve precise positioning placement are disclosed.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An optically isolated TO-can including a header with electrical connections, a laser diode mounted on the header, and a lens cap positioned over the laser diode so as to enclose and hermetically seal the laser diode, the optically isolated TO-can comprising an optical isolator positioned in the TO-can adjacent the laser diode and in the light path of light generated by the laser diode.

2. An optically isolated TO-can as claimed in claim 1 wherein the optical isolator includes an optical rotator and a 45 degree polarizer.

3. An optically isolated TO-can as claimed in claim 2 wherein the optical rotator includes a Faraday rotator with associated magnet.

4. An optically isolated TO-can as claimed in claim 2 wherein the optical rotator includes a latching garnet.

5. An optically isolated TO-can as claimed in claim 1 wherein the optical isolator includes an input polarizer having the same polarization as the laser diode, an optical rotator that rotates the polarization of incoming light 45 degrees, and an exit polarizer having a 45 degree polarization with respect to the input polarizer.

6. An optically isolated TO-can as claimed in claim 1 wherein the lens cap includes a lens in an end thereof spaced from the laser diode and positioned to direct generated light into an optical fiber.

7. An optically isolated TO-can as claimed in claim 6 wherein the spacing of the lens from the laser diode is increased by a distance equal to an actual thickness of the optical isolator minus an effective thickness of the optical isolator.

8. An optically isolated TO-can as claimed in claim 7 wherein an effective thickness of the optical isolator includes Tᵣₒₜₐₜₒᵣ/Rᵣₒₜₐₜₒᵣ+Tₚₒₗₐᵣ/Rₚₒₗₐᵣ, where: Tᵣₒₜₐₜₒᵣ=the thickness of the rotator, Rᵣₒₜₐₜₒᵣ=the index of refraction of the rotator, Tₚₒₗₐᵣ=the thickness of the polarizer, and Rₚₒₗₐᵣ=the index of refraction of the polarizer.

9. An optically isolated TO-can as claimed in claim 1 wherein the optical isolator is positioned inside the TO-can close enough to the laser diode to substantially reduce aperture size.

10. An optically isolated TO-can comprising:
a header with associated electrical leads and a component mounting structure;
a laser diode mounted on the component mounting structure and situated to direct generated light generally perpendicular to the header;
an optical isolator mounted on the component mounting structure and situated adjacent the laser diode, the optical isolator receiving generated light from the laser diode and directing the generated light perpendicularly away from the header; and
a lens cap engaged with the header and positioned over the laser diode and the optical isolator so as to enclose and hermetically seal the laser diode and the optical isolator, the lens cap being designed to optically mate and align with an externally positioned optical fiber, the lens cap including a lens in an end thereof spaced from the laser diode and positioned to direct generated light into the optical fiber.

11. An optically isolated TO-can as claimed in claim 10 wherein the optical isolator includes an optical rotator and a 45 degree polarizer.

12. An optically isolated TO-can as claimed in claim 11 wherein the optical rotator includes a Faraday rotator with associated magnet.

13. An optically isolated TO-can as claimed in claim 11 wherein the optical rotator includes a latching garnet.

14. An optically isolated TO-can as claimed in claim 10 wherein the optical isolator includes an input polarizer having the same polarization as the laser diode, an optical rotator that rotates the polarization of incoming light 45 degrees, and an exit polarizer having a 45 degree polarization with respect to the input polarizer.

15. An optically isolated TO-can as claimed in claim 10 wherein the spacing of the lens from the laser diode is increased by a distance equal to an actual thickness of the optical isolator minus an effective thickness of the optical isolator.

16. An optically isolated TO-can as claimed in claim 10 wherein the optical isolator is positioned inside the TO-can close enough to the laser diode to substantially reduce aperture size.

17. A method of fabricating an optically isolated TO-can including a header with electrical connections, a laser diode mounted on the header, and a lens cap positioned over the laser diode so as to enclose and hermetically seal the laser diode, and the lens cap including a lens in an end thereof spaced from the laser diode and positioned to direct generated light in a light path into an optical fiber, the method comprising the steps of positioning an optical isolator in the TO-can adjacent the laser diode and in the light path of light generated by the laser diode and adjusting the spacing of the laser diode from the lens to compensate for the optical isolator.

18. A method as claimed in claim 17 wherein the step of positioning the optical isolator includes providing an optical isolator including an optical rotator and a 45 degree polarizer.

19. A method as claimed in claim 17 wherein the step of providing the optical isolator includes providing a Faraday rotator with associated magnet.

20. A method as claimed in claim 17 wherein the step of providing the optical isolator includes providing a latching garnet.

21. A method as claimed in claim 17 wherein the step of providing the optical isolator includes providing an input polarizer having the same polarization as the laser diode, an optical rotator that rotates the polarization of incoming light 45 degrees, and an exit polarizer having a 45 degree polarization with respect to the input polarizer.

22. A method as claimed in claim 17 wherein the step of adjusting the spacing of the laser diode from the lens includes increasing the spacing by a distance equal to an actual thickness of the optical isolator minus an effective thickness of the optical isolator.

23. A method as claimed in claim 22 wherein an effective thickness of the optical isolator includes Tᵣₒₜₐₜₒᵣ/Rᵣₒₜₐₜₒᵣ+Tₚₒₗₐᵣ/Rₚₒₗₐᵣ, where: Tᵣₒₜₐₜₒᵣ=the thickness of the rotator, =the index of refraction of the rotator, Tₚₒₗₐᵣ=the thickness of the polarizer, and Rₚₒₗₐᵣ=the index of refraction of the polarizer.

24. A method as claimed in claim 17 wherein the step of positioning the optical isolator inside the TO-can includes positioning the optical isolator close enough to the laser diode to substantially reduce aperture size.
